(19) United States
(12) Patent Application Publication
(10) Pub. No.: US 2026/0167805 A1
(43) Pub. Date: Jun. 18, 2026

(54) SYNTHETIC BIOPLASTIC AND METHOD OF MAKING THE SAME

(71) Applicant: Bhav Jain, Boca Raton, FL (US)

(72) Inventor: Bhav Jain, Boca Raton, FL (US)

(21) Appl. No.: 18/985,918

(22) Filed: Dec. 18, 2024

(51) Int. Cl. C08L 5/12; C08L 75/12

(52) U.S. Cl. CPC C08L 5/12; C08L 75/12; C08L 2201/06; C08L 2205/025; C08L 2205/035; C08L 2207/20

(57) ABSTRACT

A synthetic bioplastic may include approximately 1.125 parts by weight of apple peel agar powder; approximately 1.125 parts by weight of orange peel agar powder; approximately 1.125 parts by weight of sargassum agar powder; approximately 1.125 parts by weight of a water-activated polyurethane formula; and approximately 110 parts by weight of water.

### TECHNICAL FIELD

The embodiments generally relate to the technical field of synthetic bioplastics.

### BACKGROUND

Conventional plastics, including clear plastic wraps, may be petroleum-based, carcinogenic, and non-biodegradable. Conventional plastics may include dioxin, a carcinogenic chemical that is based on chlorine, and may be in frequent contact with consumables food-stuffs and the human body. Conventional plastics also commonly consist of polyvinyl chloride (PVC), which is commonly used in food wrapping, leading to the leaching of toxic materials into our food supplies. This is primarily due to phthalates and plasticizers put into PVC to make it more elastic and stronger.

Burning PVC is a common means of disposing of PVC, even though burning PVC constitutes 80% of dioxin air pollution. Additionally, PVC undergoes thermally induced dehydrochlorination at temperatures very near to processing temperatures. This degradation easily propagates, leaving polyene sequences long enough to absorb visible light and change the color of the material from colorless to an undesirable transparent brown, an undesirable trait in the realm of food packaging. Therefore, there is a significant amount of product loss in the manufacturing process, which increases production and consumer costs.

The Center for Biological Diversity estimates that 3.5 million tons of PVC are discarded before any opportunity for use, and this PVC is extremely unlikely to be recycled in any way and nearly always ends up in landfills.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

According to embodiments, a synthetic bioplastic may include approximately 1.125 parts by weight of apple peel agar powder; approximately 1.125 parts by weight of orange peel agar powder; approximately 1.125 parts by weight of sargassum agar powder; approximately 1.125 parts by weight of a water-activated polyurethane formula; and approximately 110 parts by weight of water.

According to embodiments, a method of forming a synthetic bioplastic may include combining a mixture comprising approximately 1.125 parts by weight of apple peel agar powder; approximately 1.125 parts by weight of orange peel agar powder; approximately 1.125 parts by weight of sargassum agar powder; approximately 1.125 parts by weight of a water-activated polyurethane formula; and approximately 100 parts by weight of water. The method may further include stirring the mixture for approximately 30 seconds; and drying the mixture for approximately 24 hours to form the synthetic bioplastic.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a stress and strain curve of a synthetic bioplastic, according to some embodiments;

FIG. 2 illustrates a stress and strain curve of a synthetic bioplastic, according to some embodiments;

FIG. 3 illustrates a ductility curve of a synthetic bioplastic, according to some embodiments;

FIG. 4 illustrates a stress and strain curve of a synthetic bioplastic, according to some embodiments;

FIG. 5 illustrates a histogram of material properties of a synthetic bioplastic, according to some embodiments; and

FIG. 6 illustrates a flowchart of a method of making a synthetic bioplastic, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

According to embodiments, a synthetic bioplastic may include sargassum bacciferum seaweed agar, powdered sargassum seaweed sheets, glycerin, and ethyl cyanoacrylate. The synthetic bioplastic may be configured to replace petroleum based clear plastic wrap (PVDC), and act as an eco-friendly alternative to PVDC that allows for the gradual phasing out of non-biodegradable plastics.

According to embodiments, a method of forming a synthetic bioplastic may include combining a mixture comprising approximately 1.125 parts by weight of apple peel agar powder; approximately 1.125 parts by weight of orange peel agar powder; approximately 1.125 parts by weight of sargassum agar powder; approximately 1.125 parts by weight of a water-activated polyurethane formula; and approximately 100 parts by weight of water. The water may be heated to a boil prior to adding the apple peel agar powder, orange peel agar powder, the sargassum agar powder, and the water-activated polyurethane formula. The method may further include stirring the mixture for approximately 30 seconds and pouring the heated mixture into a container, tray, etc., and drying the mixture for approximately 24-48 hours to form the synthetic bioplastic.

According to embodiments, a synthetic bioplastic may include a synthetic bioplastic including approximately 1.125 parts by weight of apple peel agar powder; approximately 1.125 parts by weight of orange peel agar powder; approximately 1.125 parts by weight of sargassum agar powder; approximately 1.125 parts by weight of a water-activated polyurethane formula; and approximately 110 parts by weight of water.

In some embodiments, the synthetic bioplastic may include polyurethane prepolymers, diphenylmethane diisocyanate, tertiary amine compounds, a stabilizer, and a solvent as part of the water-activated polyurethane formula. In some embodiments, the stabilizer may include tertiary amine compounds. In some embodiments, the solvent may include acetone, methylene chloride, or both.

In some embodiments, the synthetic bioplastic has a tensile strength ranging from 18 MPa to approximately 77 MPa, a Young's modulus ranging from approximately 0.27 GPa to approximately 0.30 GPa, a toughness of approximately 14.8 MJ/m³, and a yield strength of approximately 42.5 MPa.

In practice and use, variations of the disclosed synthetic bioplastic may be utilized as a clear bioplastic film, such as a replacement for plastic wrap, general-purpose bioplastic, or for usage as bioplastic bags. Conventional plastics may include polymerizing of vinylidene chloride using acrylic esters and carboxyl groups which is more expensive to use or create compared to embodiments of the synthetic bioplastic described herein.

In this way, the disclosed synthetic bioplastic may provide a biodegradable material free from the use of dioxin. Additionally, the disclosed synthetic bioplastic may have a half-life of approximately 5.3 days when exposed to weathering and erosion, e.g., when left in contact with a continuous water or rain cycle, approximately 98% of the synthetic bioplastic biodegrades within a period of approximately 30 days.

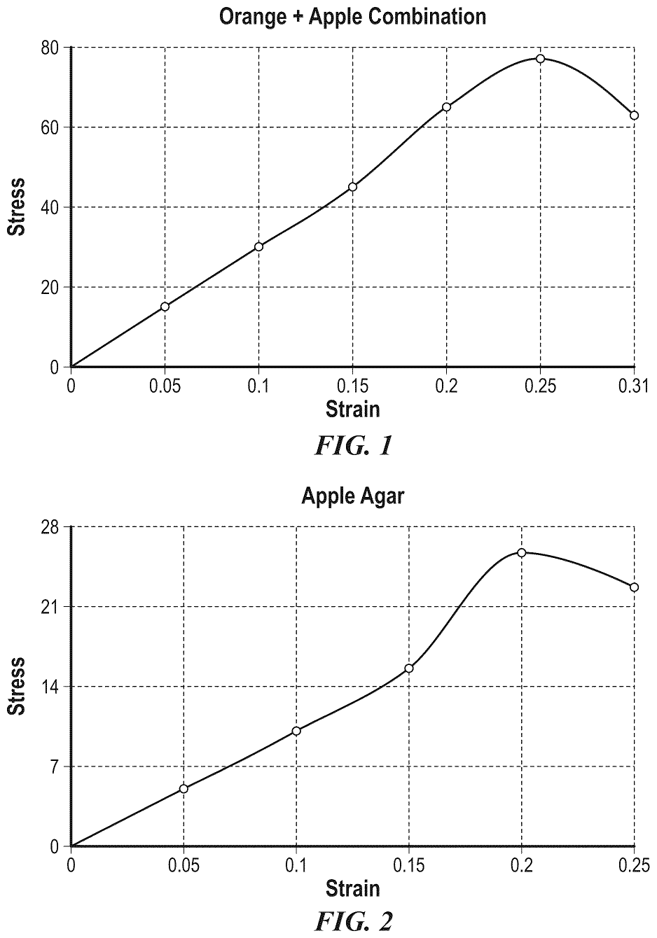

FIGS. 1-4 illustrate material properties of a synthetic bioplastic according to the methods described herein, including the results of strength and biodegradability tests on various arrangements of the synthetic bioplastic. During testing, data indicates that the synthetic bioplastic includes tensile strength and toughness exceeding typical HDPE values, and, in some embodiments, indicating toughness 113% higher than HDPE toughness. Additionally, the synthetic bioplastic demonstrated high ductility, indicating excellent deformation tolerance prior to failure.

FIG. 1 illustrates a stress and strain curve of a synthetic bioplastic including orange and apple agar (“orange & apple combination”). The synthetic bioplastic includes observer material properties including a tensile strength of approximately 77.10 MPa, an approximately 0.30 GPa Young's modulus, a yield strength of approximately 0.00 MPa, a toughness of approximately 13.8805 MJ/m³, a ductility of approximately 0.31 mm/mm, and a resilience of approximately 0.0000 MJ/m².

FIG. 2 illustrates a stress and strain curve of a synthetic bioplastic comprising apple agar. The synthetic bioplastic includes observer material properties, including a tensile strength of approximately 25.70 MPa, an approximately 0.10 GPa Young's modulus, a yield strength of approximately 0.00 MPa, a toughness of approximately 3.3875 MJ/m³, a ductility of approximately 0.25 mm/mm, and a resilience of approximately 0.0000 MJ/m².

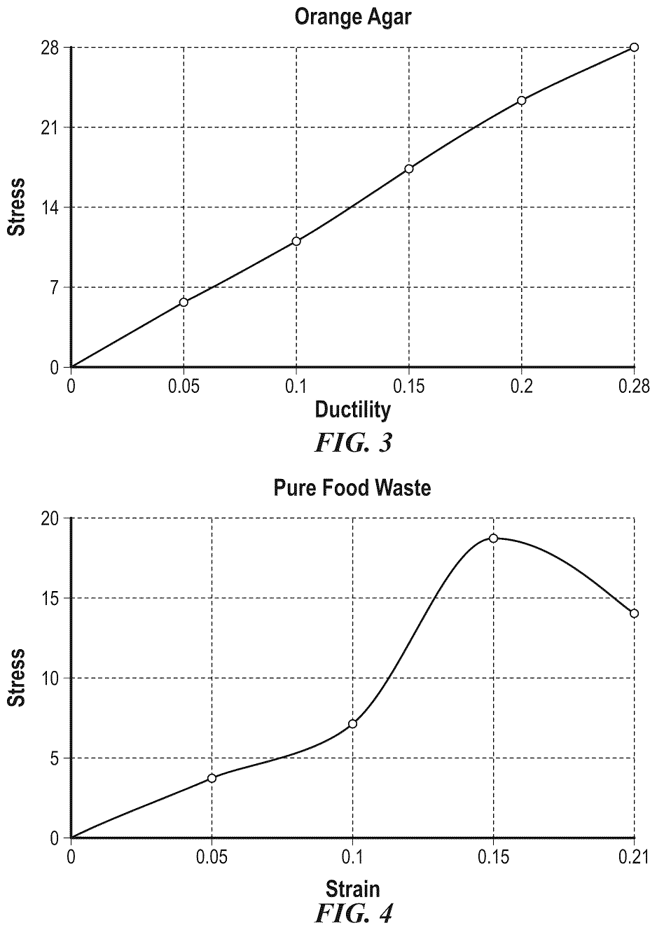

FIG. 3 illustrates a ductility curve of a synthetic bioplastic comprising orange agar. The synthetic bioplastic includes observer material properties, including a tensile strength of approximately 27.90 MPa, an approximately 0.11 GPa Young's modulus, a yield strength of approximately 0.00 MPa, a toughness of approximately 4.3363 MJ/m³, a ductility of approximately 0.28 mm/mm, and a resilience of approximately 0.0000 MJ/m².

FIG. 4 illustrates a stress and strain curve of a synthetic bioplastic comprising pure food waste. The synthetic bioplastic includes observer material properties, including a tensile strength of approximately 18.70 MPa, an approximately 0.07 GPa Young's modulus, a yield strength of approximately 0.00 MPa, a toughness of approximately 1.9885 MJ/m³, a ductility of approximately 0.21 mm/mm, and a resilience of approximately 0.0000 MJ/m².

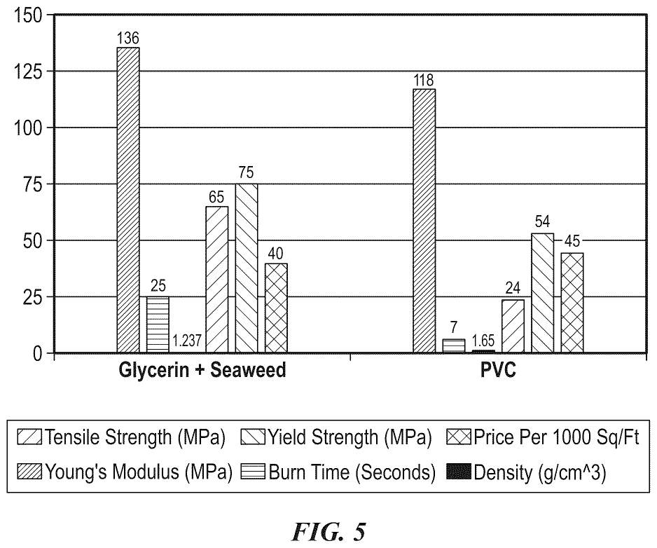

FIG. 5 illustrates a histogram of material properties of a synthetic bioplastic comprising glycerin and seaweed compared to PVC. The synthetic bioplastic includes a Young's Modules, burn time, tensile strength, and yield strength greater than PVC. The synthetic bioplastic also includes a density and price per 1000 sq/ft lower than PVC.

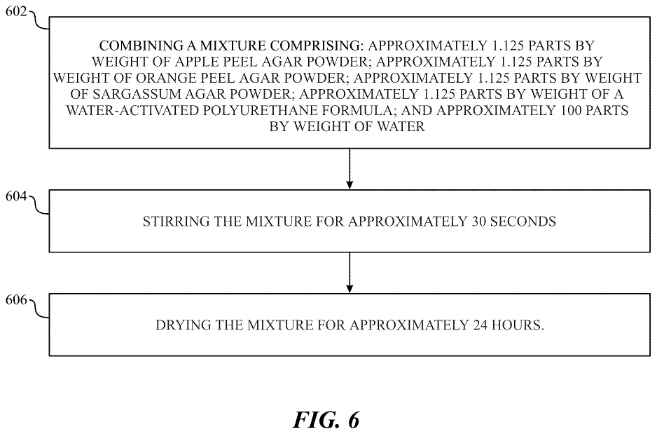

FIG. 6 illustrates a method 600 of making a synthetic bioplastic. The method may include, in step 602, combining a mixture including approximately 1.125 parts by weight of apple peel agar powder; approximately 1.125 parts by weight of orange peel agar powder; approximately 1.125 parts by weight of sargassum agar powder; approximately 1.125 parts by weight of a water-activated polyurethane formula; and approximately 100 parts by weight of water. In step 604, the method may include stirring the mixture for approximately 30 seconds. In step 606, the method may include drying the mixture for approximately 24 hours.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A synthetic bioplastic comprising:
approximately 1.125 parts by weight of apple peel agar powder;
approximately 1.125 parts by weight of orange peel agar powder;
approximately 1.125 parts by weight of sargassum agar powder;
approximately 1.125 parts by weight of a water-activated polyurethane formula; and
approximately 110 parts by weight of water;

2. The synthetic bioplastic of claim 1, wherein the product comprises a tensile strength ranging from 18 MPa to approximately 77 MPa.

3. The synthetic bioplastic of claim 1, wherein the product comprises a Young's modulus ranging from approximately 0.27 GPa to approximately 0.30 GPa.

4. The synthetic bioplastic of claim 1, wherein the product comprises a toughness of approximately 14.8 MJ/m³.

5. The synthetic bioplastic of claim 1, wherein the product comprises a yield strength of approximately 42.5 MPa.

6. The synthetic bioplastic of claim 1, wherein the water-activated polyurethane formula comprises polyurethane prepolymers, diphenylmethane diisocyanate, tertiary amine compounds, a stabilizer, and a solvent.

7. The synthetic bioplastic of claim 1, wherein the stabilizer comprises tertiary amine compounds.

8. The synthetic bioplastic of claim 1, wherein the solvent comprises at least one of acetone or methylene chloride.

9. The synthetic bioplastic of claim 1, wherein the water is approximately 100° Celsius.

10. The synthetic bioplastic of claim 1, wherein the agar powder comprises recycled food waste comprising at least one of apple, orange, or food waste agar.

11. The synthetic bioplastic of claim 1, wherein the agar powder comprises sargassum agar powder.

12. The synthetic bioplastic of claim 1, further comprising a bonding agent comprising ethyl cyanoacrylate.

13. A method of forming a synthetic bioplastic, the method comprising:
combining a mixture comprising:
approximately 1.125 parts by weight of apple peel agar powder;
approximately 1.125 parts by weight of orange peel agar powder;
approximately 1.125 parts by weight of sargassum agar powder;
approximately 1.125 parts by weight of a water-activated polyurethane formula;
and approximately 100 parts by weight of water;
stirring the mixture for approximately 30 seconds; and
drying the mixture for approximately 24 hours.

14. The method of claim 1, wherein the water activated polyurethane formula comprises polyurethane prepolymers, diphenylmethane diisocyanate, tertiary amine compounds, a stabilizer, and a solvent.

15. The method of claim 1, wherein the stabilizer comprises tertiary amine compounds.

16. The method of claim 1, wherein the solvent comprises at least one of acetone or methylene chloride.

17. The method of claim 1, wherein the water is approximately 100° Celsius.

18. The method of claim 1, wherein the agar powder comprises recycled food waste comprising at least one of apple, orange, or food waste agar.

19. The method of claim 1, wherein the recycled-food-waste-agar powder comprises sargassum agar powder.

20. The method of claim 1, wherein the combining a mixture further comprises a bonding agent comprising ethyl cyanoacrylate.
